(19) United States
(12) Patent Application Publication
(10) Pub. No.: US 2019/0026406 A1
(43) Pub. Date: Jan. 24, 2019

(54) Highly Custom and Scalable Design System and Method for Articles of Manufacture

(71) Applicant: Siege Sports, LLC, Lenexa, KS (US)

(72) Inventors: Christopher Gregory Barnes, Stilwell, KS (US); Ryan Lynn Belcher, Overland Park, KS (US); Wayne Alexander McMann, Overland Park, KS (US)

(21) Appl. No.: 15/922,783

(22) Filed: Mar. 15, 2018

Related U.S. Application Data
(63) Continuation-in-part of application No. 15/655,870, filed on Jul. 20, 2017.

(51) Int. Cl. G06F 17/50; G06T 17/00; B41J 29/393; A41H 3/00

(52) U.S. Cl. CPC G06F 17/5009; A41H 3/007; B41J 29/393; G06T 17/00

(57) ABSTRACT

A method to shorten the time from design to manufacture, includes providing a dynamic design interface for execution on a computing device, receiving a selection of an article of manufacture, and additional design input from the user specifying color, text, and graphics and placement on the article of manufacture, and dynamically generating a production-ready design file reflecting the selected article of manufacture and each of the additional design input from the user. The production-ready design file is dynamically converted to a 2-dimensional image file, which is dynamically applied to the 3-dimensional model representation for display via the dynamic design interface. The user may easily rotate the 3-dimensional model to see all sides of the design. The production-ready design file can be used as instructions to directly print the design on the article of manufacture.

### RELATED APPLICATION

This patent application is a continuation-in-part application of U.S. patent application Ser. No. 15/655,870 filed on Jul. 20, 2017, which is incorporated herein by reference. This patent application is also related to co-pending U.S. patent applications Ser. Nos. 15/717,899 and 15/717,903 filed on Sep. 27, 2017.

### FIELD

The present disclosure relates to computer-aided design systems and methods, and particularly to a highly custom and scalable design system and method for articles of manufacture.

### BACKGROUND

Computer-aided design (CAD) tools and other graphical applications programs have been in use for decades to facilitate design of a variety of items, from designing graphics for printing on a variety of surfaces, to designing semiconductor devices, to designing architectural plans, to designing machinery and automobiles, and even 3-dimensional or 3-D printing. However, these conventional tools and programs do not easily enable designs to be scalable to large productions and yet allow individual customization without human intervention.

### BRIEF DESCRIPTION OF THE DRAWINGS

FIG. 1 is a simplified block diagram of an exemplary embodiment of a highly custom and scalable design system and method for articles of manufacture according to the teachings of the present disclosure;

FIGS. 2-7 are representative screen shots of an exemplary embodiment of a highly custom and scalable design system and method for articles of manufacture according to the teachings of the present disclosure;

FIG. 8 is a simplified illustration of a graphical representation of a 2-dimensional image file of an article of manufacture according to the teachings of the present disclosure;

FIG. 9 is a simplified illustration of a tabular representation of a variable data input file used in the highly custom and scalable design system and method for articles of manufacture according to the teachings of the present disclosure;

FIG. 10 is a simplified flowchart of a design process in the highly custom and scalable design system and method for articles of manufacture according to the teachings of the present disclosure;

FIG. 11 is another simplified flowchart of a manufacture process in the highly custom and scalable design system and method for articles of manufacture according to the teachings of the present disclosure;

FIG. 12 is another simplified flowchart of a design and manufacturing process in the highly custom and scalable design system and method for articles of manufacture according to the teachings of the present disclosure;

FIGS. 13-16 are representations of a user interface of the highly custom and scalable design system and method 10 for articles of manufacture according to the teachings of the present disclosure (Story Board Concept);

FIGS. 17-22 are representations of a user interface of the highly custom and scalable design system and method 10 for articles of manufacture to illustrate the crossover concept according to the teachings of the present disclosure;

FIGS. 23 and 24 are representations of a user interface of the highly custom and scalable design system and method 10 for articles of manufacture to illustrate the image editor concept according to the teachings of the present disclosure;

FIGS. 25 and 26 are representations of a user interface of the highly custom and scalable design system and method 10 for articles of manufacture to illustrate the data aggregation and analysis concept according to the teachings of the present disclosure; and

FIGS. 27 and 28 are representations of a user interface of the highly custom and scalable design system and method 10 for articles of manufacture to illustrate the automatic messaging concept according to the teachings of the present disclosure.

### DETAILED DESCRIPTION

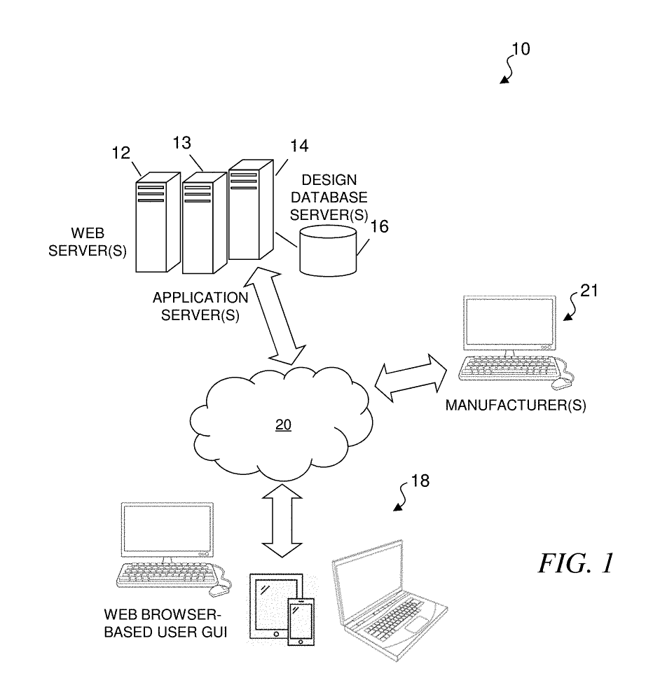

FIG. 1 is a simplified block diagram of an exemplary embodiment of a highly custom and scalable design system and method 10 for articles of manufacture according to the teachings of the present disclosure. The system or design platform 10 includes one or more servers functioning as web server(s) 12, application server(s) 13, and database server(s) 14. The web server 12 is a computer system that receives and responds to incoming requests pursuant to HTTP (Hypertext Transfer Protocol) over the Internet or World Wide Web. The application server 13 is a hardware/software framework that provides both facilities to create application programs and a server environment to run them. The database server 14 is a computer program that provides database services to store and access data in a design database 16. It should be noted that these functionalities may be handled by one server or multiple servers. The servers 12-14 and design database 16 are accessible and can communicate with a plurality of users using computing devices 18 (e.g., mobile phone, tablet computer, laptop computer, and desktop computer) via the Internet or a global computer network 20 represented by a cloud in FIG. 1. The computing devices 18 may request for a design interface web page from the web server 12 by executing a web browser application program and inputting a URL (Uniform Resource Locator) of a design website. Once the design is completed by the user, production-ready design files are stored in the design database 16, and one or more manufacturers 21 may access the database to download the production-ready design files which can be used to apply or print the designs directly onto articles of manufacture by production devices, such as printers, engravers, laser cutters, flow jets, etc.

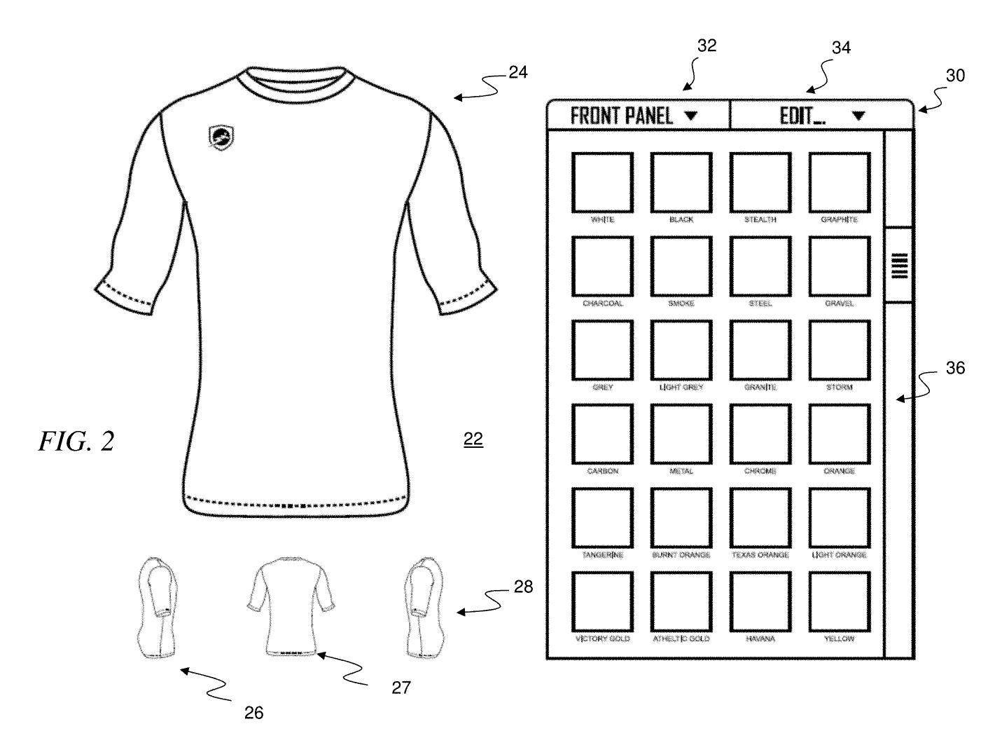

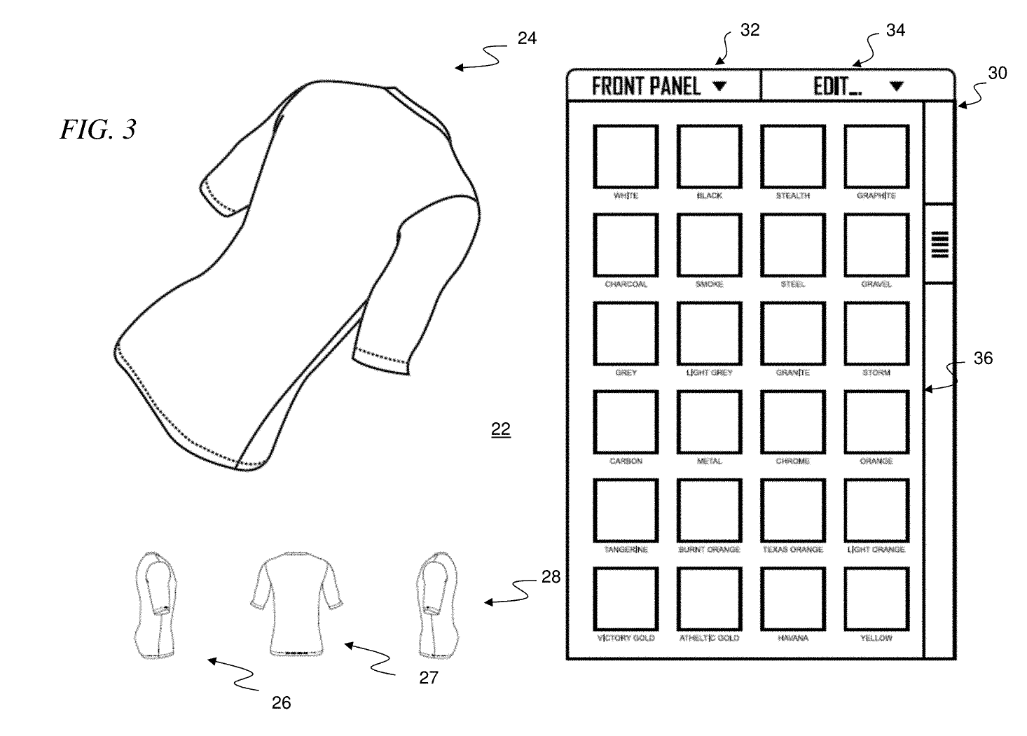

FIGS. 2-7 are representative screen shots of an exemplary embodiment of a design interface 22 of a highly custom and scalable design system and method 10 for articles of manufacture according to the teachings of the present disclosure. The design interface 22 includes a 3-dimensional primary view 24 of an article of manufacture, such as a short-sleeved sport jersey shown in FIGS. 2-7. The user may choose a particular type of article of manufacture for design input, such as sports uniforms (e.g., for football, soccer, basketball, baseball, volleyball, track, etc.), and training and warm-up garments (e.g., jerseys, henleys, shorts, tee-shirts, pants, singlets, compression sleeves, beanies, skull wraps, back sacks, compression tops, compression bottoms, V-neck tops, polos, ¼ zips, fleece hoodies, and fleece pants), coffee cups, pens, pencils, and even automobile exteriors, etc. A production-ready design file representing a template of the selected article of manufacture is generated in response to the user's selection. The production-ready design file may be, for example, a vector-based file format, such as EPS (Encapsulated PostScript), SVG (Scalable Vector Graphics), PDF (Portable Document Format), AI (Adobe Illustrator Artwork), and DXF (Drawing eXchange Format), CAD (Computer-Aided Design), CAM (Computer-Aided Manufacturing), and CAE (Abaqus/CAE CAE Model). As shown in FIG. 3, the user may manipulate the 3-dimensional model in the primary view 24 to rotate and orient the model to see different sides of the article. Also displayed by the design interface 22 are selected secondary views of the article, such as views of the right side 26, back side 27, and left side 28 of the article.

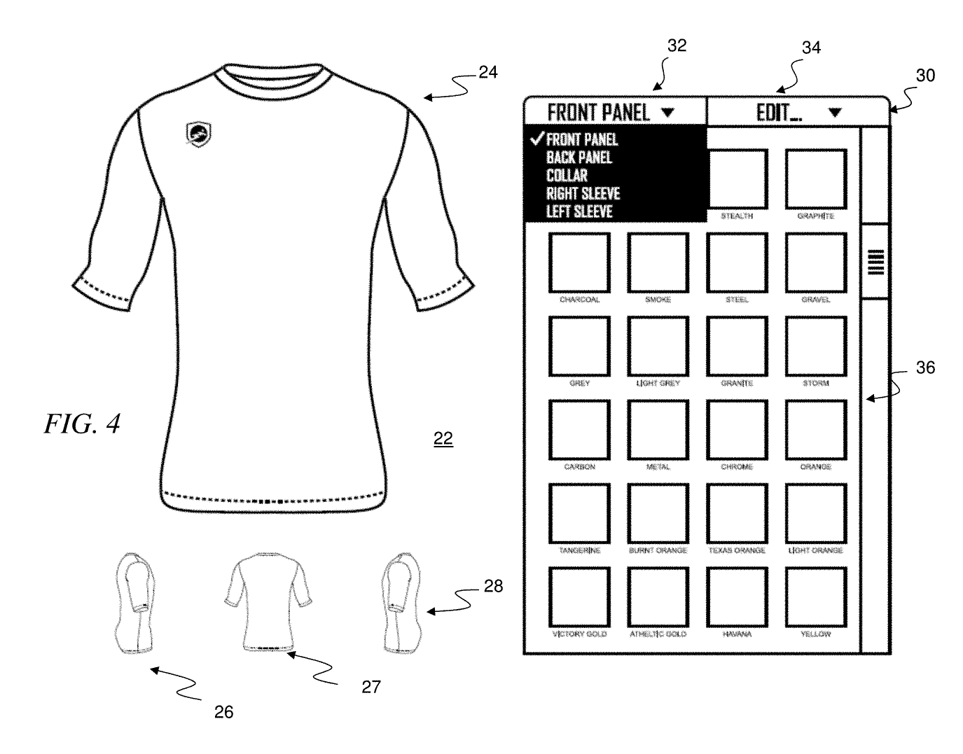

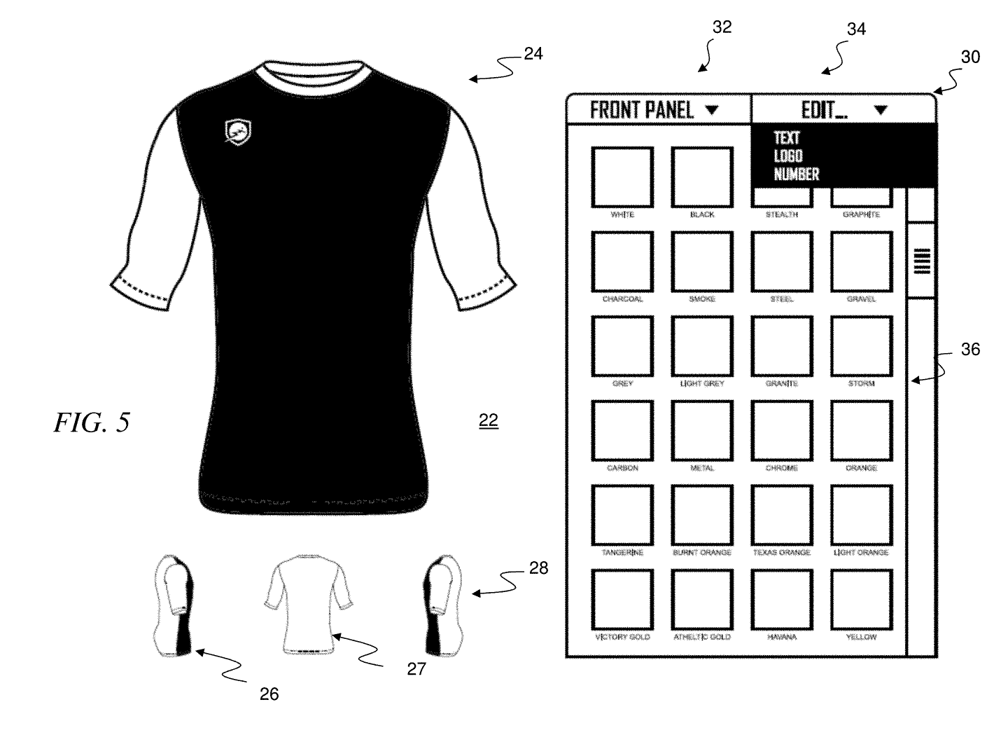

The design interface 22 also includes a design input panel 30 that enables the user to specify colors and other design elements such as text, numbers, and graphics to be added to the design. For example, an input menu 32 enables the user to select a specific portion of the article, e.g., front panel, back panel, collar, right sleeve, and left sleeve, as shown in FIG. 4. An input menu 34 enables the user to select design elements TEXT, LOGO, or NUMBER for input, as shown in FIG. 5. Alternatively, the user may specify placement of the design element by providing a coordinate measured from a predetermined point on the article. Further, a color palette 36 is provided to enable the user to specify a color to be applied to a selected portion of the article. In the example shown in FIG. 5, the user has selected a color to be added to the front panel of the jersey. As soon as the user provides a design input, the production-ready design file is dynamically updated to reflect the user's design input. The production-ready design file is then converted to a two-dimensional image file in a format such as bitmap or another image format, and applied to the 3-dimensional model shown on the screen in real-time. The image file format may include, for example, 3D Studio Max (.max, .3ds), AC3D (.AC), Apple 3DMF (.3dm/.3dmf), Autocad (.dwg), Blender (.blend), Caligari Object (.cob), Collada (.dae), Dassault (.3dxml), DEC Object File Format (.off), DirectX 3D Model (.x), Drawing Interchange Format (.dxf), DXF Extensible 3D (.x3d), Form-Z (.fmz), GameExchange2-Mirai (.gof), Google Earth (.kml/.kmz), HOOPS HSF (.hsf), LightWave (.1wo/.1ws), Lightwave Motion (.mot), MicroStation (.dgn), Nendo (.ndo), OBJ (.obj), Okino Transfer File Format (.bdf), OpenFlight (.flt), Openinventor (.iv), Pro Engineer (.slp), Radiosity (.radio), Raw Faces (.raw), RenderWare Object (.rwx), Revit (.rvt), Sketchup (.skp), Softimage XSI (.xsi), Stanford PLY (.ply), STEP (.stp), Stereo Litography (.stl), Strata StudioPro (.vis), TrueSpace (.cob), trueSpace (.cob, .scn), Universal (.u3d), VectorWorks (.mcd), VideoScape (.obj), Viewpoint (.vet), VRML (.wrl), Wavefront (.obj), Wings 3D (.wings), X3D Extensible 3D (.x3d), Xfig Export (.fig). Each design change made by the user results in a change to the production-ready design file and change to the two-dimensional image file, which leads to a real-time update of the 3-dimensional model displayed by the design interface web page. The production-ready design file produced in this manner contains instructions that can be provided as input directly to a production device for printing or applying the user's design input onto the selected article of manufacture. A production device may include, for example, printers, engravers, laser cutters, flow jets, etc.

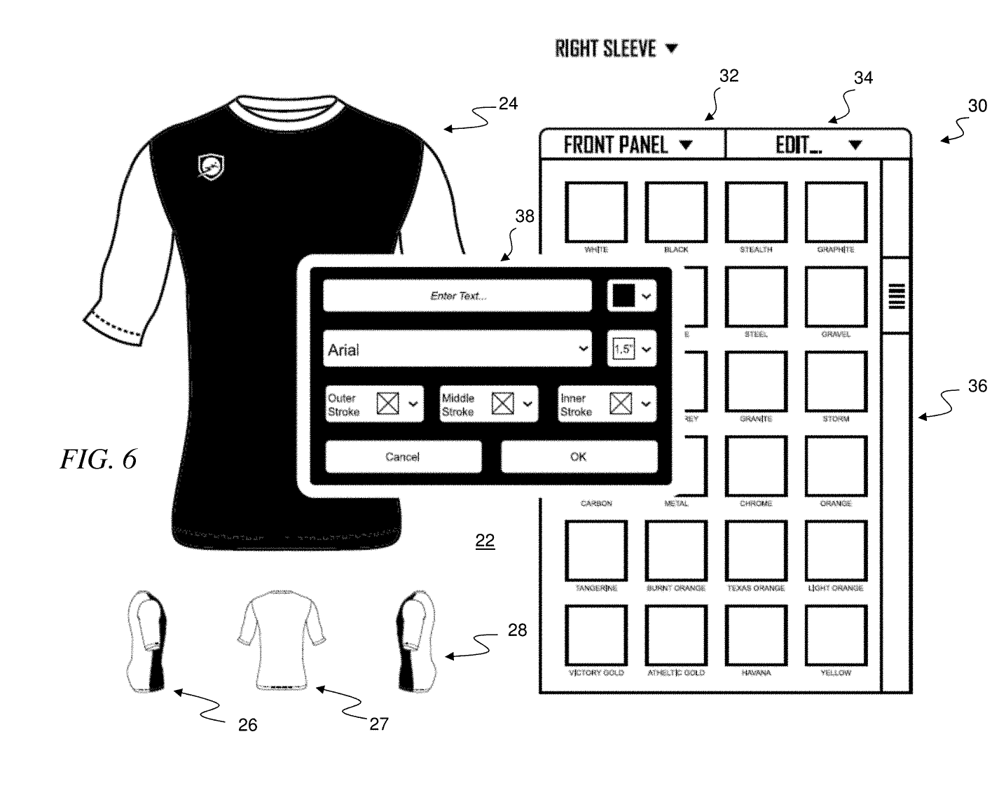

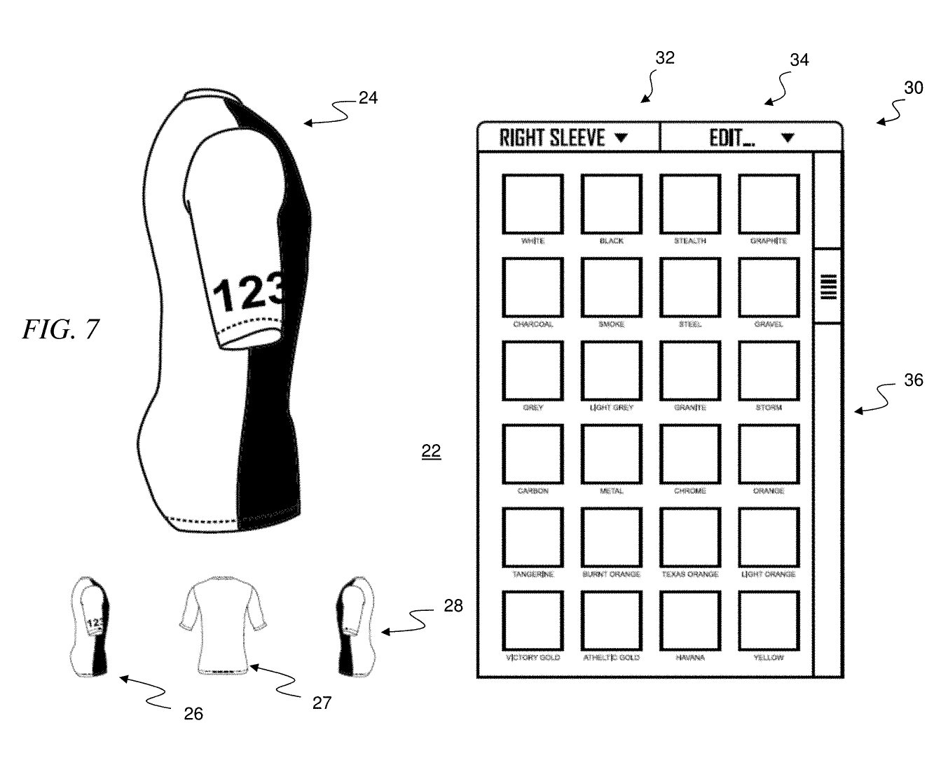

By selecting a specific portion of the article, the user may specify and choose additional design elements to be applied to the selected portion. For example, the user may select a color from the color palette 36 for the front panel of the sports jersey, as shown in FIGS. 4 and 5. As soon as the user inputs the design element, the primary and secondary views of the article of manufacture are immediately updated to reflect the addition of the new design element. As shown in FIG. 6, a text entry box 38 is displayed in response to the user's selection of “TEXT” in the input menu 34. The user may specify the text, font, size, and color(s) for the inside, middle, and outside strokes of the text. FIG. 7 shows the 3-dimensional model dynamically reflecting the user's design input of the numbers “123” applied to the right sleeve.

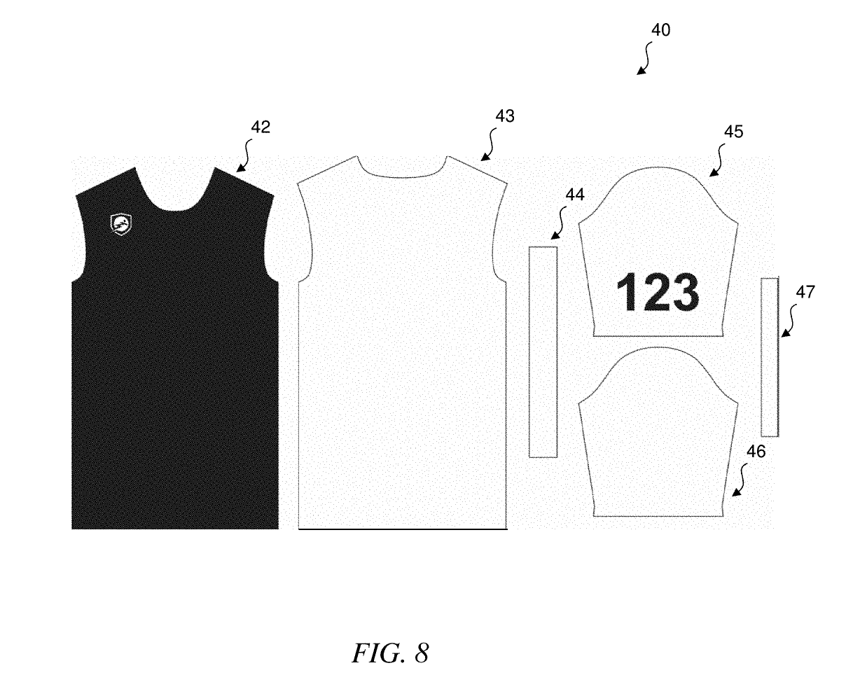

FIG. 8 is a simplified illustration of a graphical representation of a 2-dimensional image file 40 of an article of manufacture according to the teachings of the present disclosure. This 2-dimensional image file 40 is generated from the production-ready design file that contains all of the user's design inputs. The two-dimensional image file 40 includes all of the design input for all of the portions 42-47 of the article of manufacture. This 2-dimensional image file is then applied to the 3-dimensional model displayed by the dynamic design interface for viewing by the user. Each design input received from the user is reflected in the production-ready design file and in turn the 2-dimensional image file that is displayed by the dynamic design interface on the 3-dimensional model.

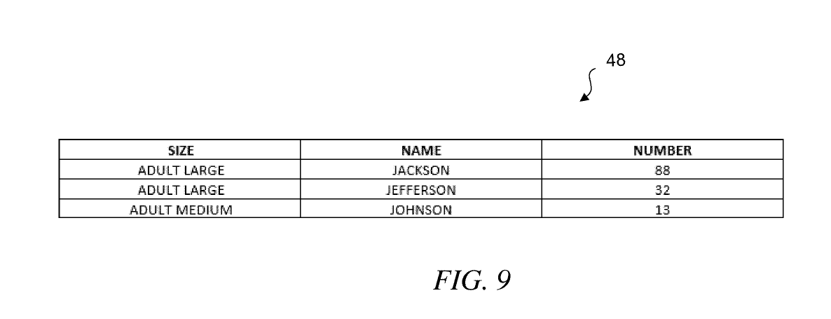

FIG. 9 is a simplified illustration of a tabular representation of a variable data input file 48 used in the highly custom and scalable design system and method 10 for articles of manufacture according to the teachings of the present disclosure. The variable data input file 48 includes data used to further customize each individual piece of article of manufacture. For example, if forty sports jerseys will be fabricated for a sports team, the name, the size, and jersey number of each player are specified in this file 48. The data from the variable data input file 48 are incorporated with the production-ready design file to generate forty individual production-ready design files, one for each player's jersey. The resultant forty production-ready files are then sent directly to the production devices/machines to apply the designs (names and numbers) onto the proper size blank jerseys to produce forty sports jerseys.

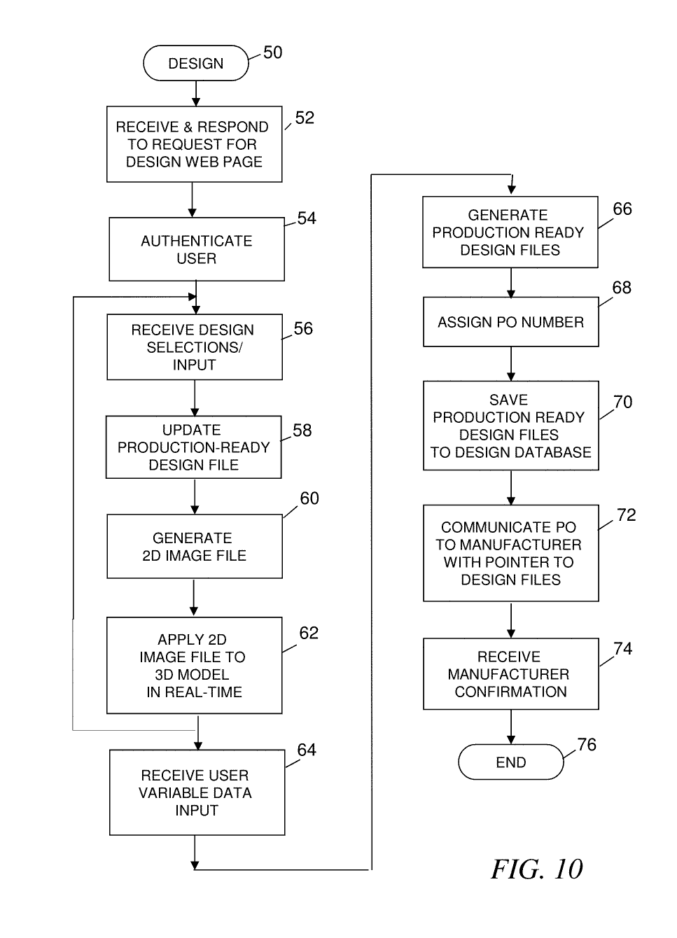

FIG. 10 is a simplified block diagram of a design process 50 in the highly custom and scalable design system and method 10 for articles of manufacture according to the teachings of the present disclosure. As shown in bocks 52 and 54, a user may create an account and login information so that the user can be authenticated prior to accessing the design interface website. The web server receives and responds to the user's request for the design interface web page in order for the user to select an article of manufacture and provide design input. A production-ready design file is created for the template of the article of manufacture selected by the user. The design interface web page displays a 3-dimensional model of the selected article of manufacture that can be manipulated and oriented by the user. In blocks 56 and 58, user design inputs and selections for color, text, number, and graphics are received, and these design inputs are reflected in the production-ready design file. The changes in the production-ready design file is also reflected in a 2-dimensional image file, which is applied to the 3-dimensional model displayed by the design interface web page in real-time, as shown in blocks 60 and 62. As these design inputs are received, the production-ready design file is updated with the additional design inputs, and the 2-dimensional image file is also updated to reflect the design inputs in real-time. The 3-dimensional model displayed on the screen of the computing device is also dynamically updated to reflect the changes. In block 64, the user may optionally upload a variable data input file that contains data to custom tailor each article to be manufactured or fabricated. A set of production-ready design files that incorporates data from the variable data input file is then generated, as shown in block 66. A unique identifier is then assigned to the job, such as a purchase order (PO) number, as shown in block 68. The files are then stored in the design database, as shown in block 70. The user may also choose to save a template file that contain at least some of the design elements so that later projects can start from the stored template instead from a blank template. In block 72, the unique identifier and a pointer to the design files in the database are communicated electronically to one or more manufacturer tasked with fabricating the articles of manufacture. The pointer may be a URL to the location of the design files. In block 74, a confirmation is received from the manufacture to acknowledge the receipt of the information for the job. The manufacturer may then download the set of production-ready design files and send them directly to the production machine. The process ends in block 76.

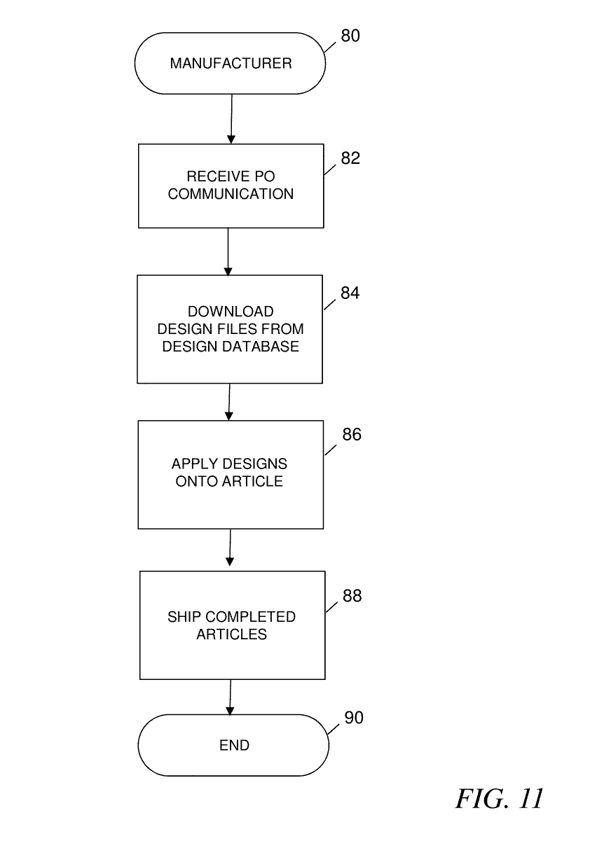

FIG. 11 is a simplified block diagram of a manufacture process 80 in the highly custom and scalable design system and method for articles of manufacture according to the teachings of the present disclosure. A manufacturer receives the electronic communication containing the unique identifier and pointer reference to the set of production-ready design files, as shown in block 82. The manufacturer downloads the design files from the design database, as shown in block 84. Access to the database by the manufacturer may require authentication before file download is granted. The manufacturer may then send the set of production-ready design files directly to the production device to print the designs onto the articles of manufacture, as shown in block 86. Thereafter in block 88 the finished articles are then shipped to a predetermined agreed-upon destination. The process ends in block 90.

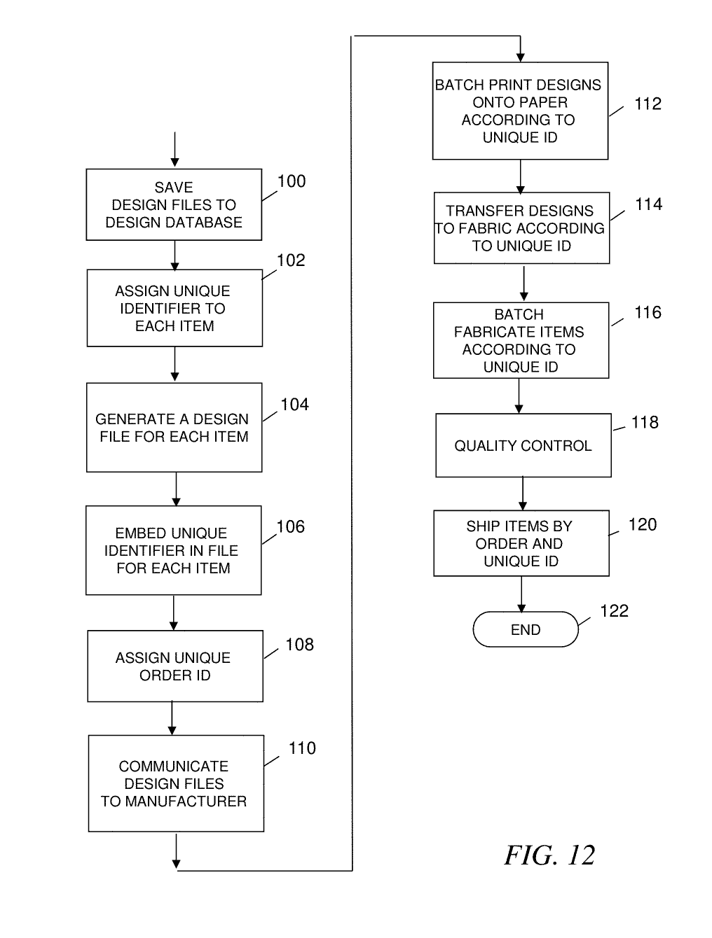

FIG. 12 is another simplified flowchart of a design and manufacturing process in the highly custom and scalable design system and method for articles of manufacture according to the teachings of the present disclosure. Referring also to FIG. 10, a vector-based design file is created for the template of the article of manufacture selected by the user. The design interface web page displays a 3-dimensional model of the selected article of manufacture that can be manipulated and oriented by the user. In blocks 56 and 58, user design inputs and selections for color, text, number, and graphics are received, and these design inputs are reflected in the vector-based design file. The changes in the vector-based design file is also reflected in a 2-dimensional image file, which is applied to the 3-dimensional model displayed by the design interface web page in real-time, as shown in blocks 60 and 62. As these design inputs are received, the vector-based design file is updated with the additional design inputs, and the 2-dimensional image file is also updated to reflect the design inputs in real-time. The 3-dimensional model displayed on the screen of the computing device is also dynamically updated to reflect the changes. Upon completion of design a user may create an account and login information so that the user can purchase the garment that has been designed. The user may provide variable data input that specifies design differences for each piece to be manufactured that bears this design. After the garment has been purchased a unique identifier code is automatically created and assigned to each piece, as shown in block 102 (FIG. 12). The unique identifier code is embedded in the design file created for each individual piece of a garment to be fabricated, as shown in blocks 104 and 106. An identifier is also assigned to the job, such as a purchase order (PO) number, as shown in block 108. The files are then stored in the design database, and transmitted to the manufacturer when an order is placed and purchased, as shown in block 110 (details described above in conjunction with FIG. 10). Upon downloading the vector-based design files, the manufacturer may send them directly to the printing machines, where the designs are printed onto paper according to the unique identifier for each piece, as shown in block 112. The designs are then transferred to fabric and fabricated according to the unique identifiers, as shown in blocks 114 and 116. All garment orders are then further batched by style/color and sewn according to their unique identifier code. Subsequently, the pieces are checked for quality control in block 118, and shipping is done according to order number and unique identifiers, as shown in block 120. The process ends in block 122.

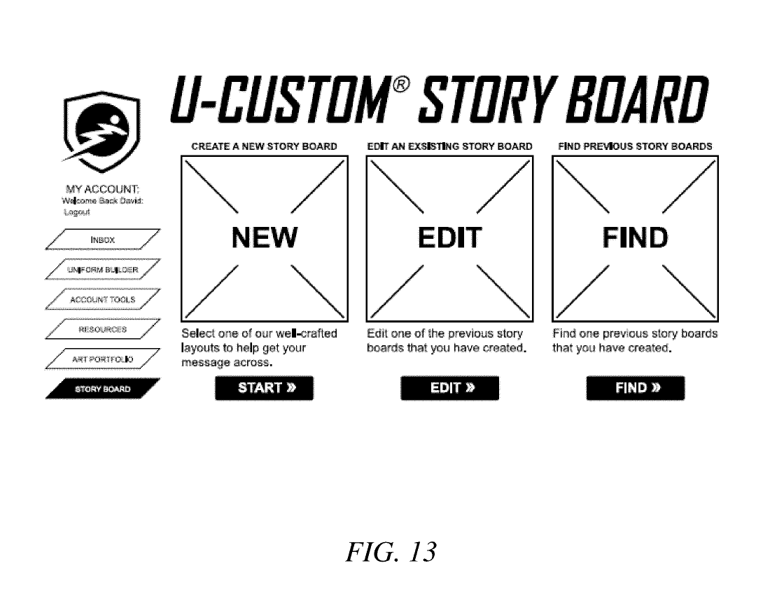

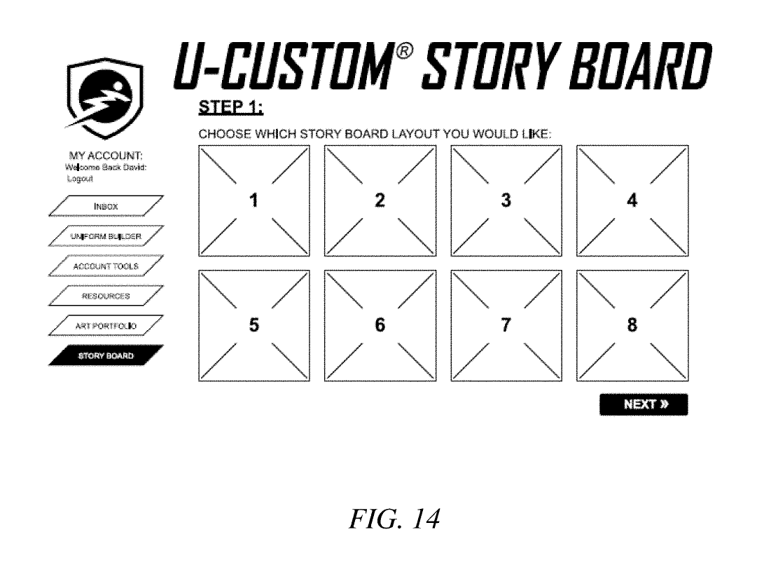

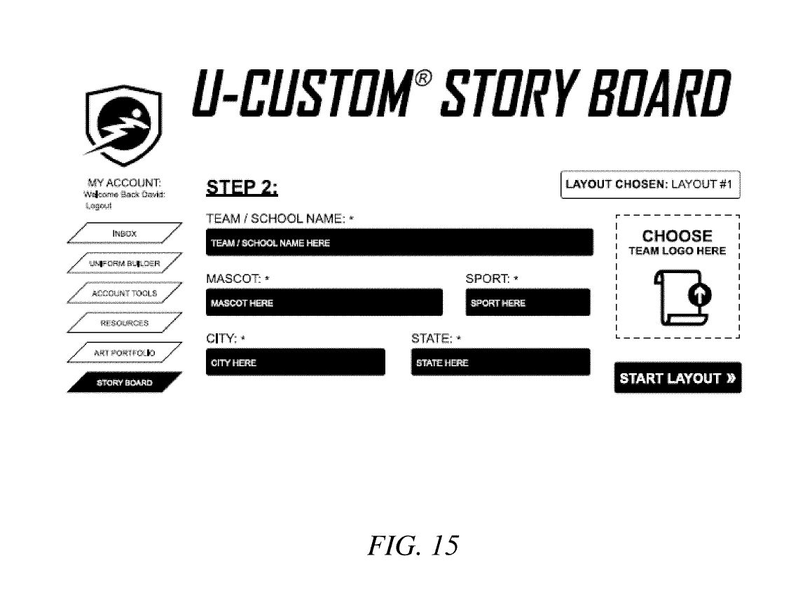

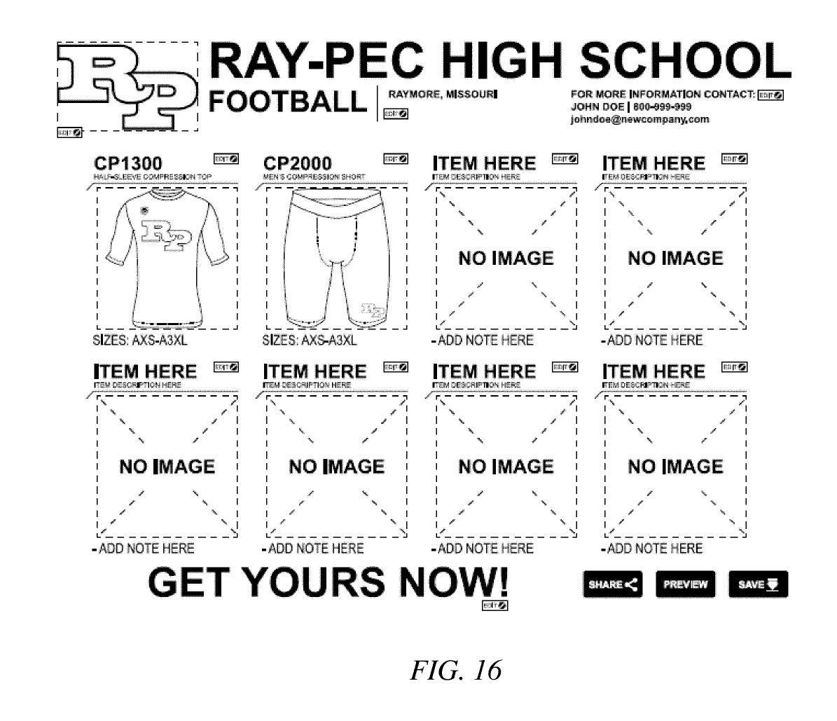

FIG. 13 is a representation of a user interface of the highly custom and scalable design system and method 10 for articles of manufacture according to the teachings of the present disclosure. This “story board” user interface is a highly customizable user interface that can be set up by the design user to enable retail users to view the design and make purchases/orders. The design user can choose to create a new design, edit an existing design, or find a previously saved design, as shown in FIG. 13. The user can then choose a dynamic 3D environment in which the design that has been created, can be uploaded, so that it can be displayed with the desired 3D environment, as shown in FIG. 14. The design interface web page displays a 3-dimensional model of the selected article that can be manipulated and oriented by the design user. The 3D environment is variable and dependent upon the product type that best displays the 3-dimensional model (e.g., bed sheets for a bed would be displayed on a bed, in a bedroom or on a bed in a guest room and so on). Multiple 3-dimensional models can be displayed within the same 3D environment so that the user can best visualize and display the product in its actual environment. The design user also has the ability to further customize the 3D environment's presentation by uploading an image, logo, or text that will be displayed in conjunction with the dynamic 3D environment, as shown in FIG. 15. The 3D environment and its corresponding 3-dimensional model/models can be saved in the design database, purchased, and/or shared via the world wide web at the design user's option. FIG. 16 is a mock-up of a user interface web page that displays 3D models of available designs/items for order/purchase by retail users. The retail user may select an item and view design details of the item from different angles. The user may also be prompted to enter specific details, such as name and player number, that become part of the design for that particular order/purchase.

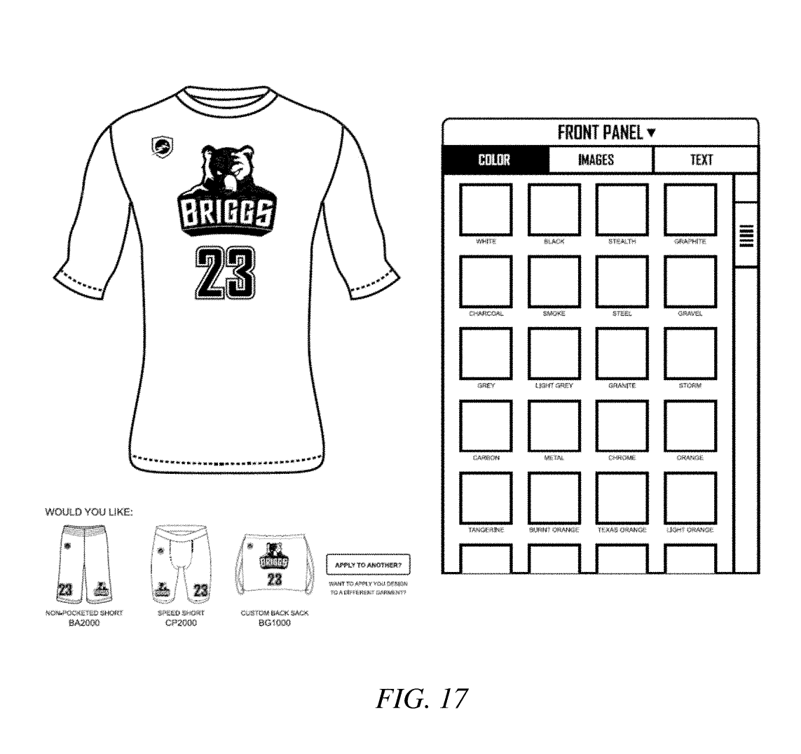

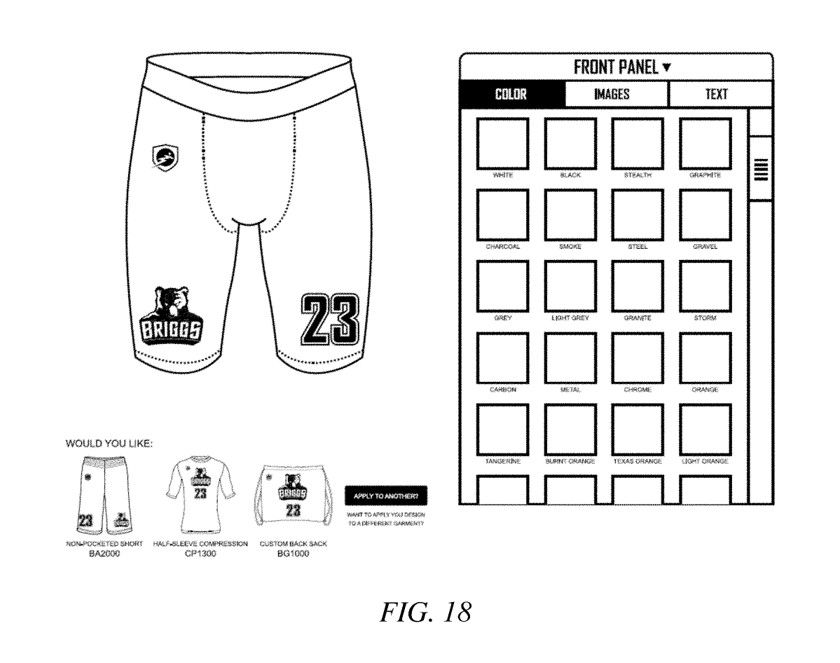

FIGS. 17-22 are representations of a user interface of the highly custom and scalable design system and method 10 for articles of manufacture to illustrate the crossover concept according to the teachings of the present disclosure. The crossover concept means that once a user has applied design elements (e.g., uploaded designs such as logos, variables such as names, numbers, colors, etc.) to a certain garment type, the system and method of the present disclosure can dynamically apply those same design elements (either identical or slightly adjusted) to other types of garments as well as other styles of the same garment type. FIG. 17 is a representative screen display of a user having applied design elements to a half-sleeve compression top, where the design elements include a mascot logo, and a number. The system and method automatically displays, in 3D rendition, a number of items (e.g., non-pocketed shorts, speed shorts, and custom back sack) that are part of the same collection (i.e., related) as the garment type the user has already selected with the user's design elements already applied to enable the user to also customize and purchase these other garment types. FIG. 18 shows a representative screen display after the user selects the speed short option. The user interface further enables the user to make adjustments, such as the placement and size of the design elements on this additional garment. As soon as the user provides a design input, the production-ready design file (e.g., a vector-based file format, such as EPS (Encapsulated PostScript), SVG (Scalable Vector Graphics), PDF (Portable Document Format), AI (Adobe Illustrator Artwork), and DXF (Drawing eXchange Format), CAD (Computer-Aided Design), CAM ( Computer-Aided Manufacturing), and CAE (Abaqus/CAE CAE Model)) is dynamically updated to reflect the user's design input. The production-ready design file is then converted to a two-dimensional image file in a format (e.g., 3D Studio Max (.max, .3ds), AC3D (.AC), Apple 3DMF (.3dm/.3dmf), Autocad (.dwg), Blender (.blend), Caligari Object (.cob), Collada (.dae), Dassault (.3dxml), DEC Object File Format (.off), DirectX 3D Model (.x), Drawing Interchange Format (.dxf), DXF Extensible 3D (.x3d), Form-Z (.fmz), GameExchange2-Mirai (.gof), Google Earth (.kml/.kmz), HOOPS HSF (.hsf), LightWave (.1wo/.1ws), Lightwave Motion (.mot), MicroStation (.dgn), Nendo (.ndo), OBJ (.obj), Okino Transfer File Format (.bdf), OpenFlight (.flt), Openinventor (.iv), Pro Engineer (.slp), Radiosity (.radio), Raw Faces (.raw), RenderWare Object (.rwx), Revit (.rvt), Sketchup (.skp), Softimage XSI (.xsi), Stanford PLY (.ply), STEP (.stp), Stereo Litography (.stl), Strata StudioPro (.vis), TrueSpace (.cob), trueSpace (.cob, .scn), Universal (.u3d), VectorWorks (.mcd), VideoScape (.obj), Viewpoint (.vet), VRML (.wrl), Wavefront (.obj), Wings 3D (.wings), X3D Extensible 3D (.x3d), Xfig Export (.fig)), and applied to the 3-dimensional model shown on the screen in real-time. The user will then be able to order and purchase both garments after the design is finalized. The types of garment/item offered may include, for example, jerseys, henleys, shorts, tee-shirts, pants, singlets, compression sleeves, beanies, skull wraps, back sacks, compression tops, compression bottoms, V-neck tops, polos, ¼ zips, fleece hoodies, and fleece pants.

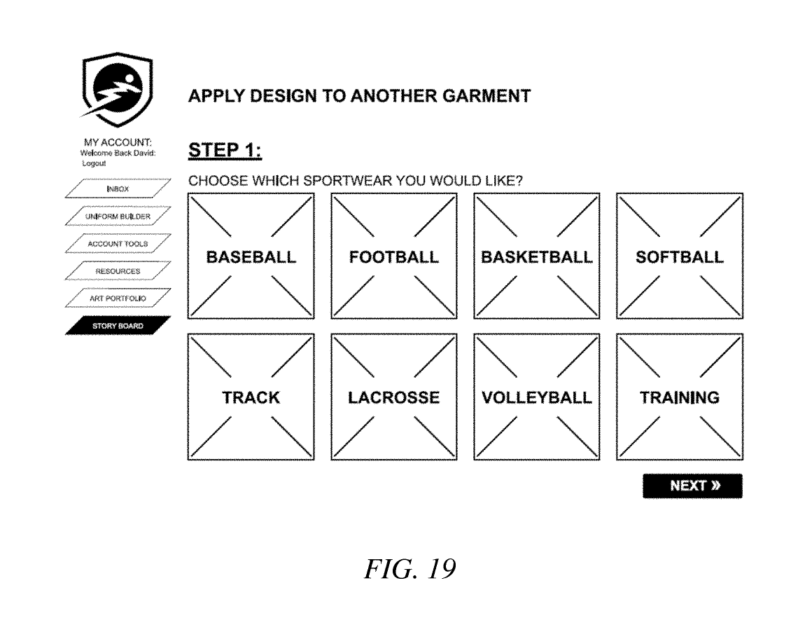

Additionally, the user may apply the same design elements to an unrelated garment type. FIG. 19 is a representative screen display that enables the user to choose another type of sport to which the same design elements may be applied. For example, the user may have applied a set of design elements to a set of football-related garments, the user may then choose the “training” option from this screen to apply the design elements to garment types designated as training garments, or choose the “baseball” option to apply the design elements to garment types designated as baseball garments. Alternatively, the user may choose to apply the design elements to accessories such as back sacks, cups, sport bottles, etc. (not explicitly shown).

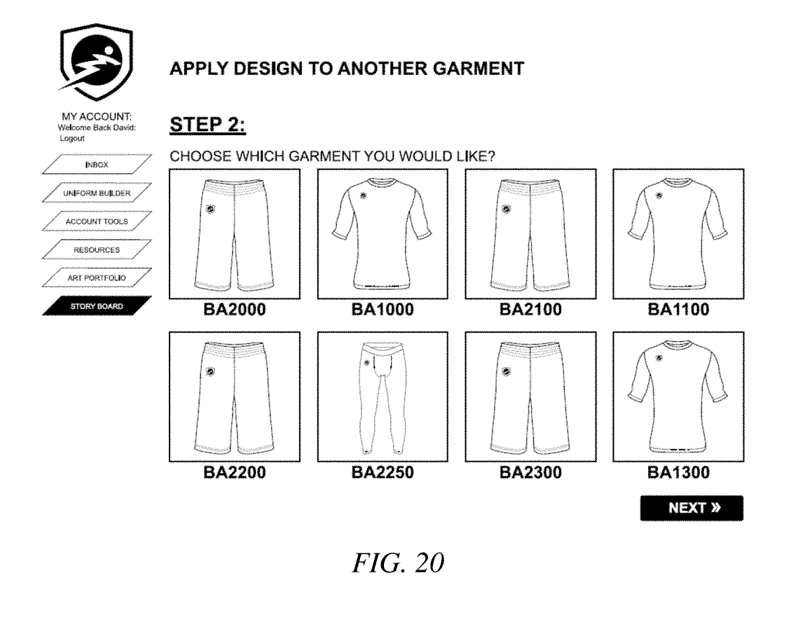

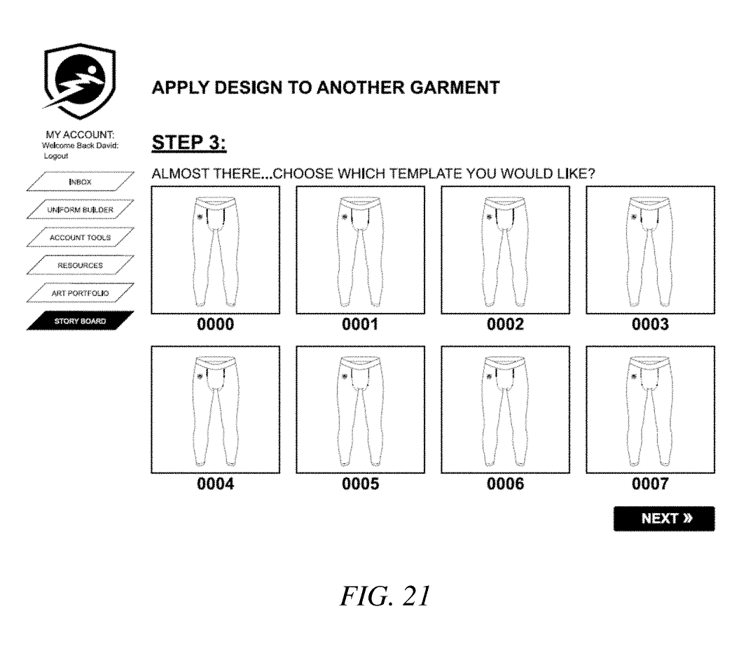

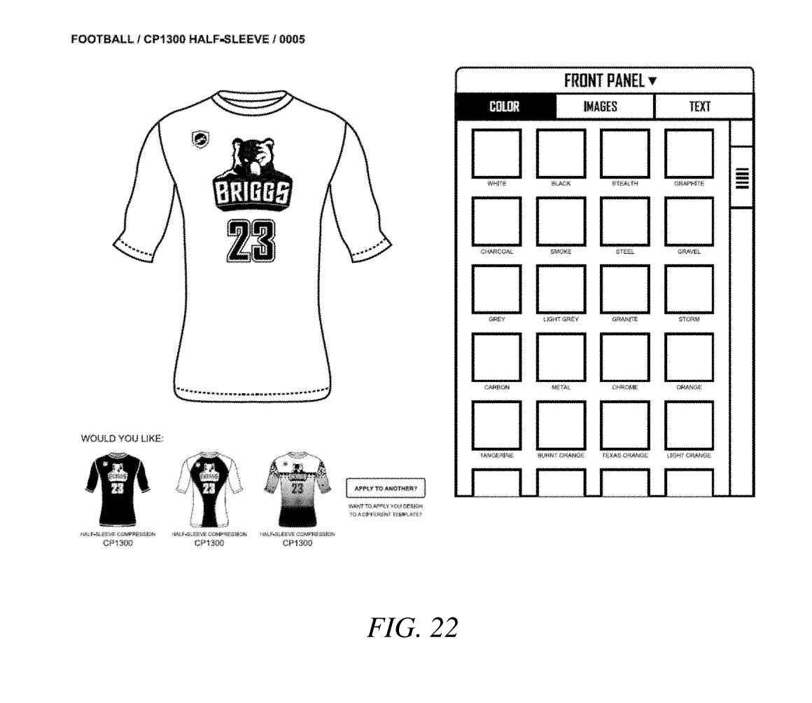

As shown in FIG. 20, once the user chose the sport, the user interface presents or displays the garment type options within the chosen sport. As shown in FIG. 21, once the user has selected a garment type, the user interface then displays a number of designs (template) for the selected garment type to enable the user to further select a particular design. The design templates provide the user with more options on placement of design elements, and variations on other aesthetic elements such as details on the sleeves and pant legs, and placement of color panels. FIG. 22 provides a representative screen that displays, in 3D, three alternative design templates for a half-sleeve compression top. Therefore, the system and method of the present disclosure is configured to dynamically apply the same set of design elements to related and unrelated garments and items. The newly selected items are rendered dynamically in 3D on the screen with the same design elements to show the user how the items will appear.

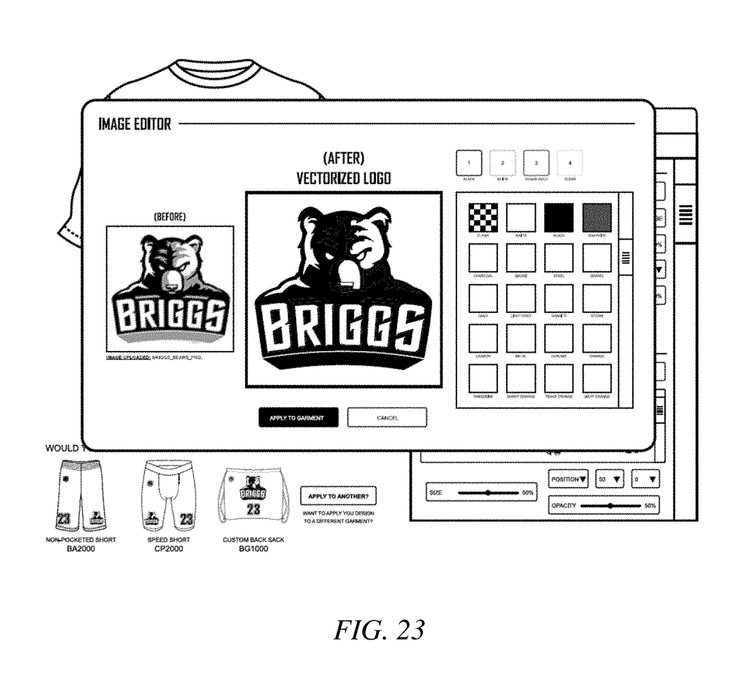

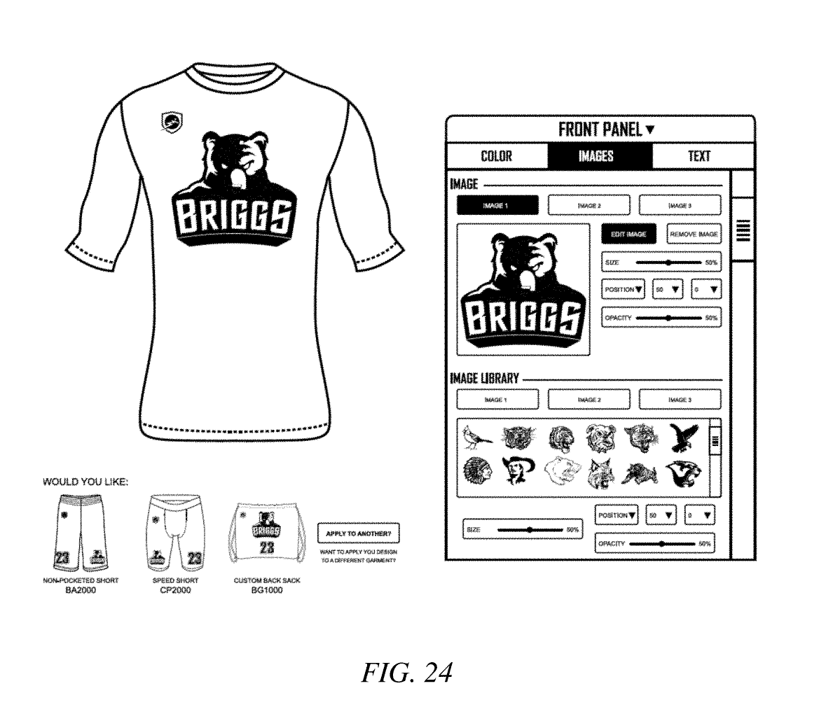

FIGS. 23 and 24 are representations of a user interface of the highly custom and scalable design system and method 10 for articles of manufacture to illustrate the image editor concept according to the teachings of the present disclosure. The image editor is a user interface that enables users to view, edit, and manipulate images in real-time in a dynamic 3D platform. The platform allows a user to select or upload and add design elements such as images, logos, text, and pictures. After the design elements have been uploaded into the platform, they are displayed dynamically to the user within the 3D environment of the platform, and the design elements are automatically vectorized, as shown in FIG. 23. Examples of a vector-based file format includes EPS (Encapsulated PostScript), SVG (Scalable Vector Graphics), PDF (Portable Document Format), AI (Adobe Illustrator Artwork), and DXF (Drawing eXchange Format), CAD (Computer-Aided Design), CAM (Computer-Aided Manufacturing), and CAE (Abaqus/CAE CAE Model)). As described above, the user's design inputs automatically cause updates in the production-ready design file in real-time, which is automatically converted to a two-dimensional image file format (e.g., 3D Studio Max (.max, .3ds), AC3D (.AC), Apple 3DMF (.3dm/.3dmf), Autocad (.dwg), Blender (.blend), Caligari Object (.cob), Collada (.dae), Dassault (.3dxml), DEC Object File Format (.off), DirectX 3D Model (.x), Drawing Interchange Format (.dxf), DXF Extensible 3D (.x3d), Form-Z (.fmz), GameExchange2-Mirai (.gof), Google Earth (.kml/.kmz), HOOPS HSF (.hsf), LightWave (.1wo/.1ws), Lightwave Motion (.mot), MicroStation (.dgn), Nendo (.ndo), OBJ (.obj), Okino Transfer File Format (.bdf), OpenFlight (.flt), Openinventor (.iv), Pro Engineer (.slp), Radiosity (.radio), Raw Faces (.raw), RenderWare Object (.rwx), Revit (.rvt), Sketchup (.skp), Softimage XSI (.xsi), Stanford PLY (.ply), STEP (.stp), Stereo Litography (.stl), Strata StudioPro (.vis), TrueSpace (.cob), trueSpace (.cob, .scn), Universal (.u3d), VectorWorks (.mcd), VideoScape (.obj), Viewpoint (.vet), VRML (.wrl), Wavefront (.obj), Wings 3D (.wings), X3D Extensible 3D (.x3d), Xfig Export (.fig)), and applied to the 3-dimensional model shown on the screen in real-time, such as shown in FIG. 24. The image editor dynamically allows the user to select, manipulate, and alter the size, color/colors, and appearance of the design elements. While the user is manipulating the image within the image editor the adjustments that the user is making are automatically and dynamically reflected in the production-ready design file and automatically converted to the two-dimensional image file that is displayed on a 3D model shown on the screen, so that the users can see the adjustments that they are making in real-time. The image editor allows the design elements to be digitally rendered while also a creating a way by which the data can be automatically vectorized, stored, and outputted to a production-ready device at the manufacturer. The newly vectorized design elements are saved in the platform's database and can be used on other item/garment types and design templates and accessible by one or more manufacturers via the global network. The user also has the ability to further customize their items by selecting the colors, patterns, logos, names, numbers, placement of any design element, and other options to further tailor their designs.

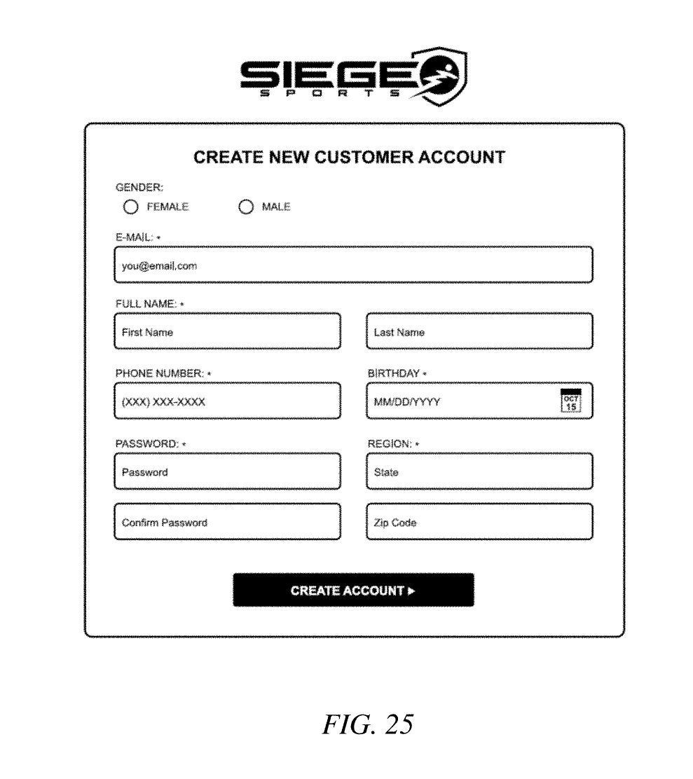

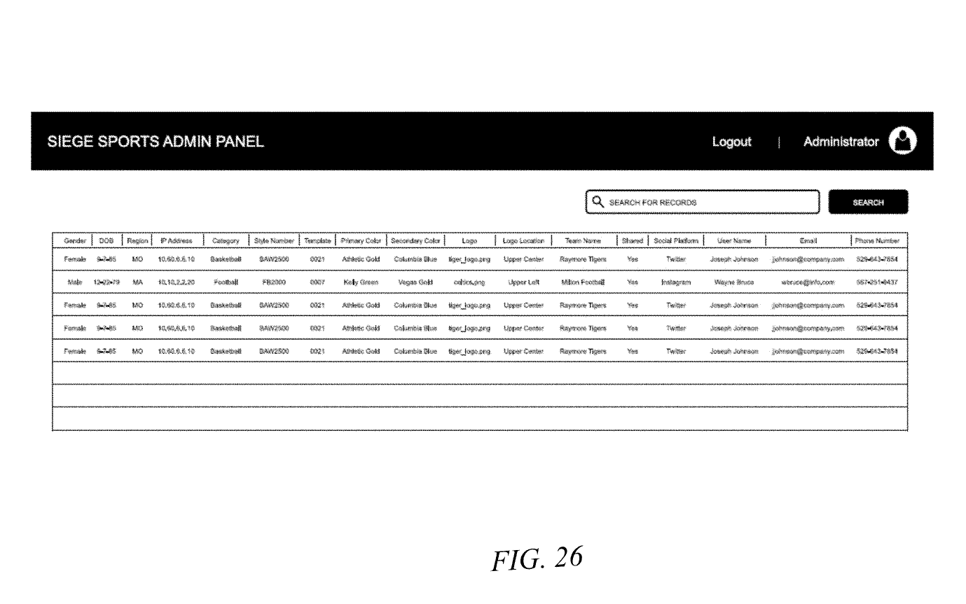

FIGS. 25 and 26 are representations of a user interface of the highly custom and scalable design system and method 10 for articles of manufacture to illustrate the data aggregation and analysis concept according to the teachings of the present disclosure. While users are using the design platform 10 to design, customize, and order items, their activity, behavior, and data entry are collected and analyzed in order to tailor the platform's behavior with the goal of enhancing the users' overall experience. For example, predictive analytics, user behavior analytics, and/or artificial intelligence may be used to anticipate user's desires and preferences. Further, the collected data may be used to establish trends and preferences over certain user populations to understand, for example, regional trends, preference by age groups and gender, etc. FIG. 25 shows a representative user interface screen to receive user input to establish a customer account, including gender, email, name, phone number, birthdate, address, etc. that would be used to organize and analyze the collected data. The platform tracks the user's inputs, preferences, and selections, browsing history, order history, and maintains the data in an organized manner, shown representatively in FIG. 26. The platform may apply predictive analytics, user behavior analytics, and/or artificial intelligence to anticipate the user's preferences and future selections, and to make recommendations and suggestions that are tailored to each user.

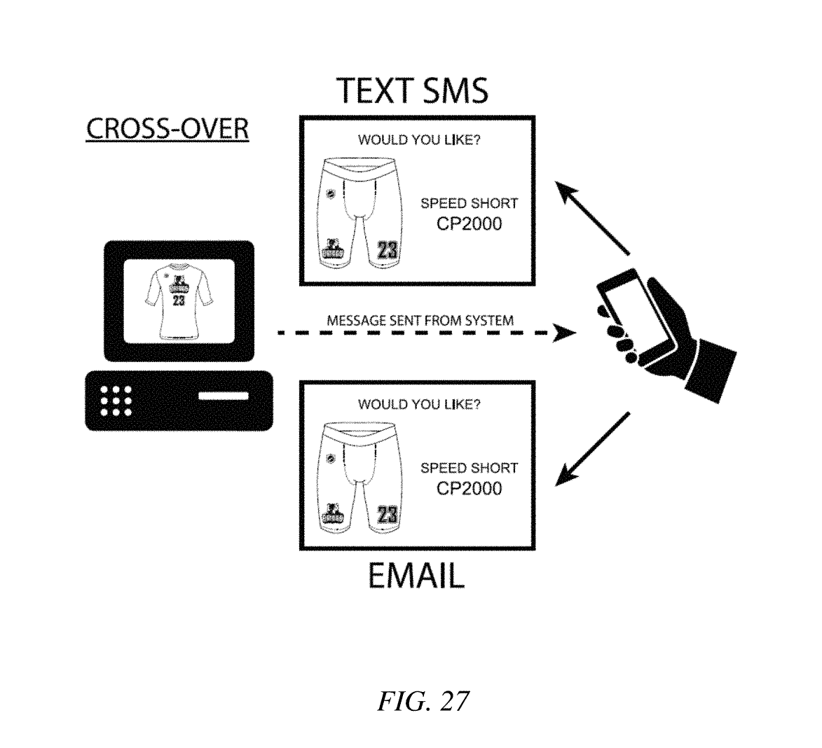

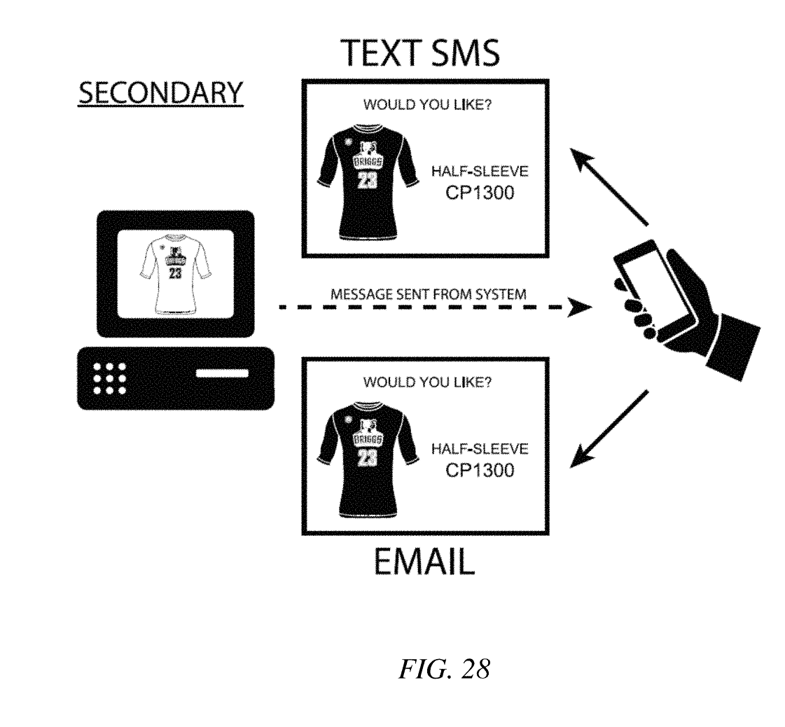

FIGS. 27 and 28 are representations of a user interface of the highly custom and scalable design system and method 10 for articles of manufacture to illustrate the automatic messaging concept according to the teachings of the present disclosure. The platform 10 is automatically scheduled to communicate with a user regarding recommended crossover and secondary items based on the user's prior browsing and shopping history, preferences, selections, etc. The platform may send a message, such as an email and/or text message, containing the user's design elements rendered on a 3D model of recommended items. For example, the recommendation message may show the user's design elements on speed shorts based on the user's prior purchase of a half-sleeve compression top, as shown in FIG. 27. As another example shown in FIG. 28, the recommendation message may show the user's design elements on a half-sleeve compression top but using a secondary color of the team's color scheme, where the user's prior purchase of the same garment but based on a primary color of the team's color scheme.

The custom design system and method described herein are able to drastically reduce the time from design to finished product in addition to giving the user the ability to specify custom design elements for the articles of manufacture down to the individual items. The entire design process to manufacture is highly automated and easily scalable to different types of articles sharing the same design elements and high production volumes.

The features of the present invention which are believed to be novel are set forth below with particularity in the appended claims. However, modifications, variations, and changes to the exemplary embodiments described above will be apparent to those skilled in the art, and the system and method described herein thus encompasses such modifications, variations, and changes and are not limited to the specific embodiments described herein.

The custom design system and method described herein are able to highly automate the time from design to manufacture giving the user the ability to specify custom design elements for the articles of manufacture down to the individual items. The entire design process to manufacture is highly automated and easily scalable to different types of articles sharing the same design elements and high production volumes as well as single item productions.

It should be noted that the word “printing” used herein loosely means to apply some form of design to a surface in the form of, but not limited to, inks, cutting, engraving, embossing, molding, and 3D printing.

The features of the present invention which are believed to be novel are set forth below with particularity in the appended claims. However, modifications, variations, and changes to the exemplary embodiments described above will be apparent to those skilled in the art, and the system and method described herein thus encompasses such modifications, variations, and changes and are not limited to the specific embodiments described herein.

What is claimed is:

1. A method, comprising:
receiving a request for a dynamic design interface web page from a computing device via a global communication network;
transmitting the dynamic design interface web page to the computing device, the dynamic design interface web page being configured to receive user design input for a design and dynamically render and display the design on a 3-dimensional model representation;
receiving a first selection from the user selecting an article of manufacture;
receiving a second selection from the user selecting a design template of the selected article of manufacture;
receiving additional design inputs from the user specifying at least one graphic design element and its placement on the article of manufacture;
receiving at least one color design input from the user and specifying its placement on the article of manufacture;
receiving at least one text design input from the user and specifying its placement on the article of manufacture;
automatically and dynamically generating and updating a production-ready design file reflecting each of the design inputs from the user;
automatically and dynamically converting the dynamically updated production-ready design file to a 2-dimensional image file reflecting each of the design inputs from the user;
automatically and dynamically applying the 2-dimensional image file to the 3-dimensional model representation of the selected template representing the article of manufacture reflecting, in real-time, each of the design inputs from the user and automatically transmitting the 3-dimensional model representation to the computing device for display via the dynamic design interface web page;
continually receiving user manipulation of the 3-dimensional model representation;
continually and automatically update the display of the 3-dimensional model representation on the computing device to reflect the user's manipulation input; and
at the user's request, generating and storing a final set of production-ready design files containing design printing instructions for the article of manufacture.

2. The method of claim 1, further comprising:
receiving a user's specification of a portion of the article of manufacture; and
receiving a user's specification of at least one color for the selected portion of the article of manufacture.

3. The method of claim 1, further comprising:
receiving a user's selection of a portion of the article of manufacture; and
receiving a user's selection of at least one pattern for the selected portion of the article of manufacture.

4. The method of claim 1, further comprising:
receiving an image file containing the at least one graphic design element; and
automatically converting the image file to a production-ready design file format.

5. The method of claim 1, further comprising:
receiving an image file containing the at least one graphic design element;
automatically displaying the at least one graphic design element in the received image file;
automatically converting the image file to a production-ready design file format;
automatically displaying the at least one graphic design element in the production-ready design file;
receiving further user design inputs from the user to modify the at least one graphic design element;
automatically updating the at least one graphic design element in the production-ready design file reflecting the further user design inputs; and
automatically updating the display of the at least one graphic design element in the production-ready design file.

6. The method of claim 1, wherein dynamically generating a production-ready design file comprises dynamically generating a file with a format selected from the group consisting of EPS (Encapsulated PostScript), SVG (Scalable Vector Graphics), PDF (Portable Document Format), AI (Adobe Illustrator Artwork), DXF (Drawing eXchange Format), CAD (Computer-Aided Design), CAM (Computer-Aided Manufacturing), and CAE (Abaqus/CAE CAE Model).

7. The method of claim 1, wherein automatically and dynamically converting to a 2-dimensional image file comprises converting to a format selected from the group consisting of 3D Studio Max (.max, .3ds), AC3D (.AC), Apple 3DMF (.3dm/.3dmf), Autocad (.dwg), Blender (.blend), Caligari Object (.cob), Collada (.dae), Dassault (.3dxml), DEC Object File Format (.off), DirectX 3D Model (.x), Drawing Interchange Format (.dxf), DXF Extensible 3D (.x3d), Form-Z (.fmz), GameExchange2-Mirai (.gof), Google Earth (.kml/.kmz), HOOPS HSF (.hsf), LightWave (.1wo/.1ws), Lightwave Motion (.mot), MicroStation (.dgn), Nendo (.ndo), OBJ (.obj), Okino Transfer File Format (.bdf), OpenFlight (.flt), Openinventor (.iv), Pro Engineer (.slp), Radiosity (.radio), Raw Faces (.raw), RenderWare Object (.rwx), Revit (.rvt), Sketchup (.skp), Softimage XSI (.xsi), Stanford PLY (.ply), STEP (.stp), Stereo Litography (.stl), Strata StudioPro (.vis), TrueSpace (.cob), trueSpace (.cob, .scn), Universal (.u3d), VectorWorks (.mcd), VideoScape (.obj), Viewpoint (.vet), VRML (.wrl), Wavefront (.obj), Wings 3D (.wings), X3D Extensible 3D (.x3d), Xfig Export (.fig).

8. A system, comprising:
a database communicably coupled to a global computer network;
a web server configured to:
receive a request for a dynamic design interface web page from a computing device;
transmit the dynamic design interface web page to the computing device in response to the request;
receive design inputs from the user selecting a design template of an article of manufacture;
receive additional design inputs from the user specifying at least one graphic design element and its placement on the article of manufacture;
receive at least one color design input from the user and specifying its placement on the article of manufacture;
receive at least one text design input from the user and specifying its placement on the article of manufacture;
automatically and dynamically generate and update a production-ready design file reflecting each of the design inputs from the user;
automatically and dynamically convert the dynamically updated production-ready design file to a 2-dimensional image file reflecting each of the design inputs from the user;
automatically and dynamically applying the 2-dimensional image file to the 3-dimensional model representation of the selected template representing the article of manufacture reflecting, in real-time, each of the design inputs from the user;
automatically transmit the 3-dimensional model representation to the computing device for display via the dynamic design interface web page, the 3-dimensional model being rotatable by user manipulation;
continually receive additional user design inputs and continually automatically and in real-time update the production-ready design file, 2-dimensional image file, and 3-dimensional model representation to reflect the additional user design inputs;
continually and automatically transmit the updated 3-dimensional model representation to the computing device for display; and
at user's request, generate and store, in real-time, a final set of production-ready design files, each production-ready design file containing design printing instructions for the article of manufacture.

9. The system of claim 8, wherein the web server is further configured to:
receive a user's specification of a portion of the article of manufacture; and
receive a user's specification of at least one color for the selected portion of the article of manufacture.

10. The system of claim 8, wherein the web server is further configured to:
receive a user's selection of a portion of the article of manufacture; and
receive a user's selection of at least one pattern for the selected portion of the article of manufacture.

11. The system of claim 8, wherein the web server is further configured to:
receive an image file containing the at least one graphic design element; and
automatically convert the image file to a production-ready design file format.

12. The system of claim 8, wherein the web server is further configured to:
receive an image file containing the at least one graphic design element;
automatically display the at least one graphic design element in the received image file;
automatically convert the image file to a production-ready design file format;
automatically display the at least one graphic design element in the production-ready design file;
receive further user design inputs from the user to modify the at least one graphic design element;
automatically update the at least one graphic design element in the production-ready design file reflecting the further user design inputs; and
automatically update the display of the at least one graphic design element in the production-ready design file.

13. The system of claim 8, wherein the web server is further configured to dynamically generate a production-ready design file with a format selected from the group consisting of EPS (Encapsulated PostScript), SVG (Scalable Vector Graphics), PDF (Portable Document Format), AI (Adobe Illustrator Artwork), DXF (Drawing eXchange Format), CAD (Computer-Aided Design), CAM (Computer-Aided Manufacturing), and CAE (Abaqus/CAE CAE Model).

14. The system of claim 8, wherein the web server is further configured to automatically and dynamically converting to a 2-dimensional image file having a format selected from the group consisting of 3D Studio Max (.max, .3ds), AC3D (.AC), Apple 3DMF (.3dm/.3dmf), Autocad (.dwg), Blender (.blend), Caligari Object (.cob), Collada (.dae), Dassault (.3dxml), DEC Object File Format (.off), DirectX 3D Model (.x), Drawing Interchange Format (.dxf), DXF Extensible 3D (.x3d), Form-Z (.fmz), GameExchange2-Mirai (.gof), Google Earth (.kml/.kmz), HOOPS HSF (.hsf), LightWave (.1wo/.1ws), Lightwave Motion (.mot), MicroStation (.dgn), Nendo (.ndo), OBJ (.obj), Okino Transfer File Format (.bdf), OpenFlight (.flt), Openinventor (.iv), Pro Engineer (.slp), Radiosity (.radio), Raw Faces (.raw), RenderWare Object (.rwx), Revit (.rvt), Sketchup (.skp), Softimage XSI (.xsi), Stanford PLY (.ply), STEP (.stp), Stereo Litography (.stl), Strata StudioPro (.vis), TrueSpace (.cob), trueSpace (.cob, .scn), Universal (.u3d), VectorWorks (.mcd), VideoScape (.obj), Viewpoint (.vet), VRML (.wrl), Wavefront (.obj), Wings 3D (.wings), X3D Extensible 3D (.x3d), Xfig Export (.fig).

15. A computer-readable medium having encoded thereon instructions for executing a method, comprising:
receiving a request for a dynamic design interface web page from a computing device;
transmitting the dynamic design interface web page to the computing device, the dynamic design interface web page being configured to receive user design input for a design and dynamically render and display the design on a 3-dimensional model representation;
receiving a first selection from the user selecting an article of manufacture;
receiving a second selection from the user selecting a design template of the selected article of manufacture;
receiving additional design inputs from the user specifying at least one graphic design element and its placement on the article of manufacture;
transmitting the 3-dimensional model representation of the selected design template of the selected article manufacture with the at least one graphic design element to the computing device for display via the dynamic design interface web page;
dynamically, in real-time, generating and updating a production-ready design file reflecting each of the design inputs from the user;
dynamically, in real-time, converting the production-ready design file to a 2-dimensional image file and updating the 2-dimensional image file to reflect each of the design inputs from the user;
dynamically, in real-time, applying the 2-dimensional image file to the 3-dimensional model representation of the selected template representing the article of manufacture reflecting each of the design inputs from the user being displayed by the computing device via the dynamic design interface web page;
continually receiving user manipulation of the 3-dimensional model representation;
continually and automatically update the display of the 3-dimensional model representation on the computing device to reflect the user's manipulation input; and
at the user's request, generating and storing a final set of production-ready design files containing design printing instructions for the article of manufacture.

16. The method of claim 15, further comprising:
receiving an image file containing the at least one graphic design element;
automatically displaying the at least one graphic design element in the received image file;
automatically converting the image file to a production-ready design file format;
automatically displaying the at least one graphic design element in the production-ready design file;
receiving further user design inputs from the user to modify the at least one graphic design element;
automatically updating the at least one graphic design element in the production-ready design file reflecting the further user design inputs; and
automatically updating the display of the at least one graphic design element in the production-ready design file.
